(19) United States
(12) Patent Application Publication
(10) Pub. No.: US 2003/0138026 A1
(43) Pub. Date: Jul. 24, 2003

(54) Temperature exposure indication accessory

(76) Inventor: Philip Bailey Askeland, Garsfontein (ZA)

Correspondence Address: AKERMAN SENTERFITT, P.O. BOX 3188, WEST PALM BEACH, FL, 33402-3188, US

(21) Appl. No.: 10/350,511

(22) Filed: Jan. 24, 2003

Related U.S. Application Data
(63) Continuation-in-part of application No. PCT/ZA01/00103, filed on Jul. 24, 2001.

(30) Foreign Application Priority Data
Jul. 26, 2000 (ZA) ZA 2000/3749

(51) Int. Cl. G01K 11/00

(52) U.S. Cl. 374/162

(57) ABSTRACT

The invention provides an temperature exposure indication accessory (10) which consists of an enclosure (12) having a transparent cover face (14). The enclosure (12) is fixed to packaging (18) of a frozen article. The enclosure (12) contains a substance that is transformable when exposed to any temperature below freezing point for a predetermined period of time such as parts (16, 20) formed of differently coloured iced water. The environmental conditions under which the parts (16, 20) will melt, mix and, accordingly change overall colour are approximately equivalent to the conditions under which the quality of the frozen article will be compromised.

### FIELD OF THE INVENTION

This invention relates to a temperature exposure indication accessory for use with an article to verify that the article has been consistently maintained within a certain temperature range.

### BACKGROUND TO THE INVENTION

It is often difficult for suppliers of frozen foods, plants, flowers, laboratory products, medicinal products, pathological samples, photographic and X-ray film, and the like to ensure that the quality of their products is not compromised in transit or storage. The difficulty lies in establishing whether the product has been continuously maintained at a sufficiently low temperature to preserve the quality thereof. Quality inspections require that packaging be opened and the produce be visually inspected to detect damage due to inadequate control of ambient temperatures.

Furthermore, poor cooling facilities can affect the shelf-life of an article without immediately affecting the appearance of the article, so sub-standard quality goods go largely undetected.

A need thus exists for a temperature exposure indication accessory with which some of the aforesaid disadvantages can be overcome or at least be alleviated.

The Applicant is aware of a frozen food thaw indicator disclosed in UK patent application GB 2 215 460 A to PHELAN, Ashley, John. This thaw indicator consists of a simple ice cube which is made from a mildly dyed water solution placed in a clear plastic bag. This indicator changes shape if it melts and is accordingly only suitable to indicate whether or not it has been exposed to temperatures in excess of the melting point of ice, for example, about 0° C. at sea level.

### SUMMARY OF THE INVENTION

According to a first aspect of the invention there is provided a temperature exposure indication accessory including a substance which is transformable on exposure for a predetermined duration, to temperatures within a predetermined temperature range, the accessory being attachable to an article at a temperature outside the predetermined temperature range to provide a visual indicator indicating whether the article has been exposed to a temperature within the predetermined temperature range,

provided that, in the case of the substance being water, the substance is transformable by way of a change of colour.

The accessory may include an enclosure in which said substance is enclosed and which enclosure is attachable to or forms part of a package the temperature exposure of which is required to be indicated.

At least part of the enclosure may be transparent to permit a user to determine by sight whether the substance in the enclosure has transformed thereby indicating that it has been exposed to a temperature within the predetermined temperature range.

At least part of the enclosure may be flexible to permit a user to determine by touch whether the substance in the enclosure has transformed thereby indicating that it has been exposed to a temperature within the predetermined temperature range.

The substance may be transformable from a solid state to a liquid state. The substance may transform at a predetermined temperature depending on the indicatory requirements of the. accessory.

The shape of the substance may be transformable. The substance may be pre-shaped so that transformation of the substance changes the shape of the substance in a manner which is easy to detect. The substance may be pre-shaped in the shape of a star, animal, figure, letter or letters, word or words, number or numbers, date, and/or the like.

The colour of the substance may be transformable. The substance may include at least two differently coloured parts which mix together upon transformation so as to change colour. The substance may include a special dye which changes colour at a predetermined temperature such as a dye found in popular toys, dolls (for example, where the doll's hair changes colour when placed in a fridge), or the like.

The accessory may include at least one other substance which is transformable on exposure for a predetermined duration, to temperatures within a different predetermined temperature range than the first mentioned substance, so as to provide a visual indicator indicating whether the article has been exposed to temperatures within at least two different predetermined temperature ranges.

The accessory may include a graphical representation of how the substance should look should no transformation have taken place so that a user is able to visually compare the substance with the graphical representation to determine whether or not the substance has transformed.

According to a second aspect of the invention, there is provided an enclosure for a substance which is transformable on exposure for a predetermined duration, to temperatures within a predetermined temperature range, the enclosure being a receptacle having a sealing lid which is at least partially transparent.

According to a third aspect of the invention there is provided an item of packaging for a frozen produce including a temperature exposure indication accessory including a substance which is transformable on exposure for a predetermined duration, to temperatures within a predetermined temperature range, the accessory being attachable to an article at a temperature outside the predetermined temperature range to provide a visual indicator indicating whether the article has been exposed to a temperature within the predetermined temperature range,

provided that, in the case of the substance being water, the substance is transformable by way of a change of colour.

The accessory may form an integral part of the item of packaging.

The accessory may be permanently attached to the item of packaging.

The accessory may be temporarily attached to the item of packaging.

According to a further aspect of the invention, there is provided a method of indicating temperature exposure of a frozen article including the steps of:

providing an enclosure having therein a transformable substance at a temperature outside of a predetermined temperature range, provided that, in the case of the substance being water, the substance is transformable by way of a change of colour; and

providing the article with the enclosure at a temperature outside the predetermined temperature range for indicating, at a later time, whether the article has been exposed to a temperature within the pre-determined temperature range.

The method includes the user, at the later time, either visually inspecting the enclosure to determine whether the substance has transformed, or feeling the enclosure with their fingers to determine whether the shape and/or texture and/or configuration of the substance in the enclosure has transformed.

### BRIEF DESCRIPTION OF THE DRAWINGS

The invention is described below by way of example only and with reference to the accompanying drawings in which:

FIG. 1 shows a perspective view of one embodiment of a temperature exposure indication accessory attached to packaging of a frozen product;

FIG. 2 shows a perspective view of the temperature exposure indication accessory shown in FIG. 1;

FIG. 3 shows a front view of another embodiment of the accessory attached to packaging of a product indicating that the product has been exposed to temperatures within a predetermined temperature range;

FIG. 4 shows a front view of a further embodiment of the accessory indicating a predetermined transformation temperature when in solid state at a) and a mere mixture at b) when in liquid state;

FIG. 5 shows a front view of a yet further embodiment of the accessory indicating an expiry date of the produce when in solid state at a) and a mere mixture at b) when in liquid state;

FIG. 6 shows a front view of a variation of the embodiment of the accessory shown in FIGS. 1 and 2 when in solid state at a) and a mere mixture at b) when in liquid state; and

FIGS. 7 and 8 each show a perspective view of a different variation in shape of the embodiment of the accessory shown in FIG. 3 when in solid state at a) and a mere mixture at b) when in liquid state.

### DETAILED DESCRIPTION OF THE DRAWINGS

A temperature exposure indication accessory according to the invention is generally designated in the drawings by reference numeral 10.

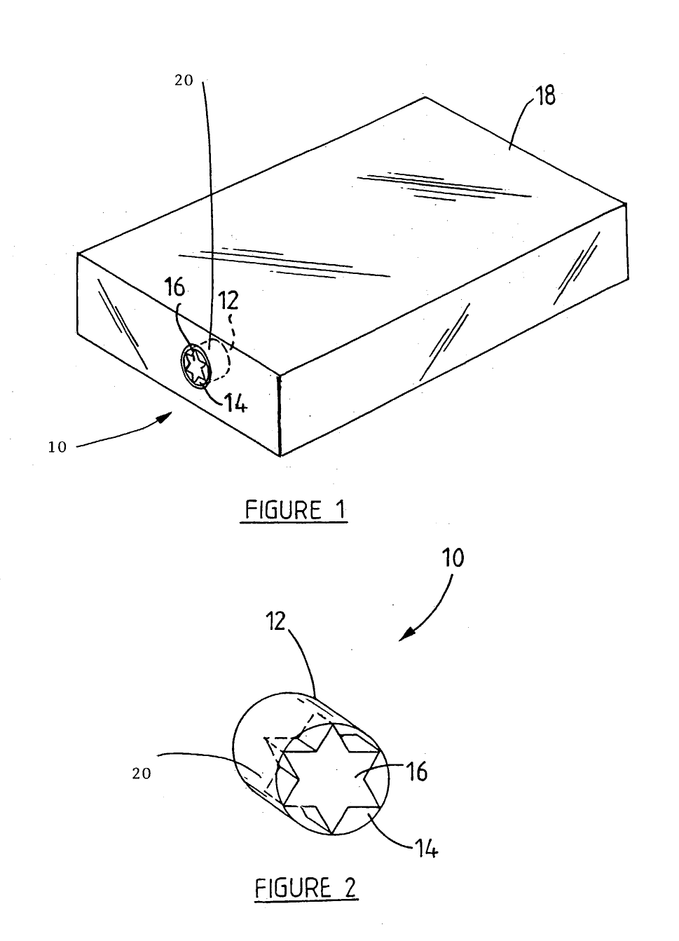

The accessory 10 consists of an enclosure 12 having a transparent cover face 14. The enclosure 12 is fixed to packaging 18 of a frozen article. The enclosure 12 contains a substance that is transformable when exposed to any temperature below freezing point for a predetermined period of time. In the embodiment shown in FIGS. 1 and 2, the substance includes a frozen, star-shaped part 16 formed of iced water, and coloured blue, for example, to be easily distinguishable from the packaging 18 of the frozen article. The substance also includes a frozen, cylindrical part 20 which contains part 16. Part 20 is formed of iced water, and coloured yellow, for example, to be easily distinguishable from part 16 and the packaging 18 of the frozen article. The environmental conditions under which part 16 and part 20 will melt are approximately equivalent to the conditions under which the quality of the frozen article will be compromised.

In use, an enclosure 12 having a transparent cover face 14 is attached to packaging 18 of a frozen article. Part 16 is produced by freezing blue coloured liquid water in a star-shaped mould and part 20 is produced by freezing yellow coloured liquid water in a cylindrical mould having a corresponding star-shaped void. Parts 16, 20 are then removed from the moulds and part 16 fitted within part 20. Before the frozen article leaves a supplier, the fitted parts 16, 20 are inserted into the enclosure 12.

If, at a later time, the frozen article and accessory 10 are exposed to predetermined non-ideal ambient temperature conditions (for example about 0° C. at sea level), parts 16, 20 will melt, mix together, and change overall colour (to green in this example). The change in the nature and overall colour of parts 16, 20 (even if re-frozen again later on) will alert merchants or consumers to the fact that the frozen article to which the accessory 10 is attached, has been exposed to ambient temperature conditions which have compromised the quality of the goods.

There is no need for the frozen articles to be visually inspected by opening or removing the packaging 18 because the temperature exposure indication accessory 10 will verify that ambient temperature conditions in transit or storage means have been consistently maintained within a predetermined temperature range if its original nature and overall colour remain.

It is envisaged that in this manner, the device will provide a convenient and reliable means of indicating whether a large number of articles have been safely stored or transported without any detrimental effects to the quality of the frozen articles by virtue of the temperature conditions of the storage or transit means.

Even where the produce is again exposed to suitable temperatures, the parts 16, 18 will have changed nature and overall colour which indicates that the produce was exposed to high temperatures for a certain time.

It is to be appreciated that in another embodiment of the invention (not shown), the substance may include a special dye which changes colour at a predetermined temperature such as a dye found in popular toys, dolls (for example, where the doll's hair changes colour when placed in a fridge), or the like. Accordingly, it is to be appreciated that the invention includes in its scope any substance which is chemically formulated to change colour on exposure to a temperature that is below or above a certain threshold.

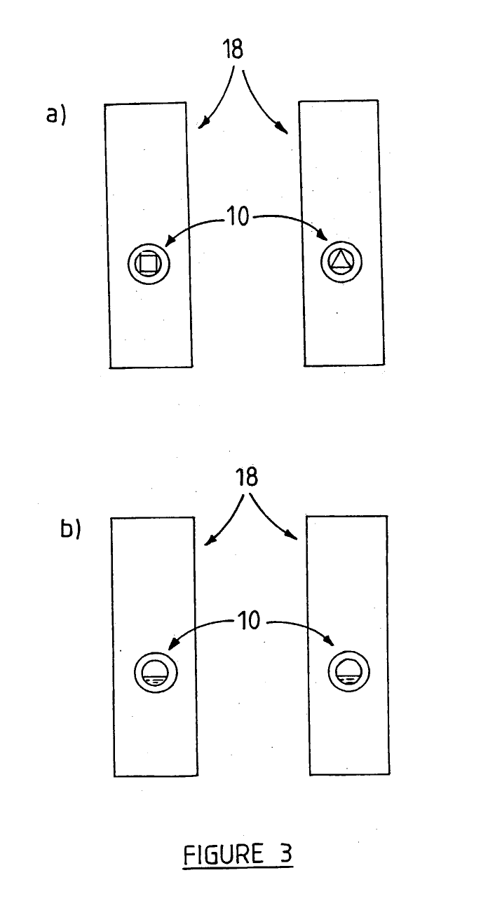

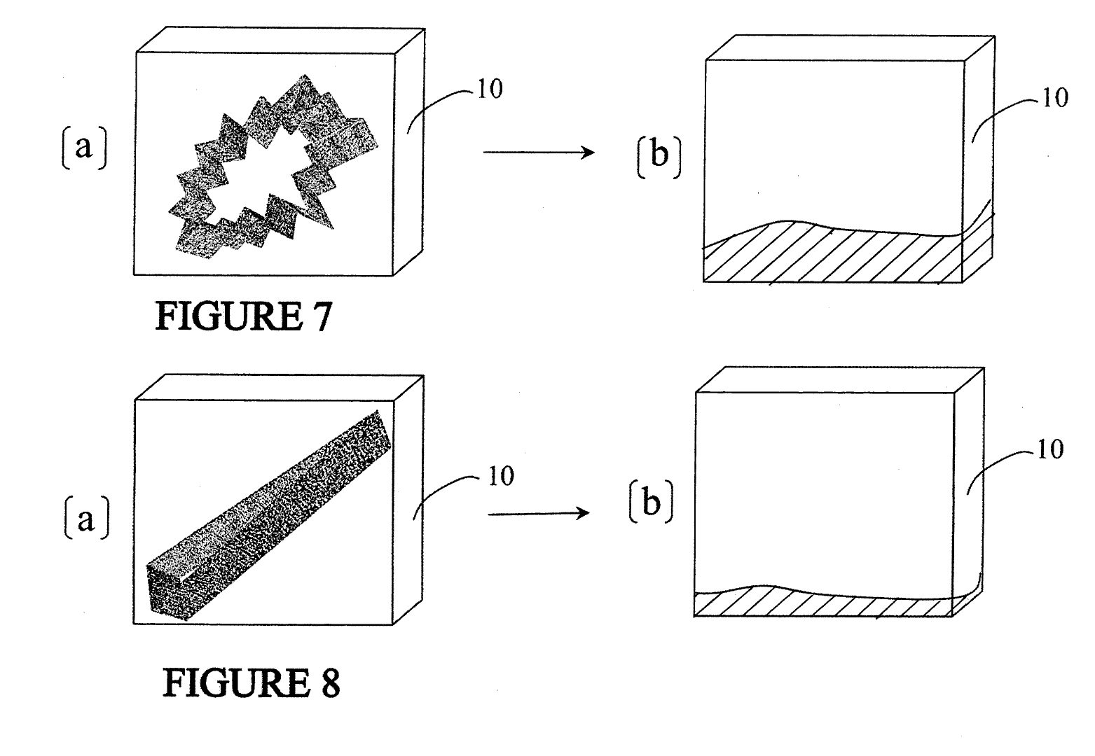

FIG. 3 shows a further embodiment of the invention wherein the overall shape of the substance is transformable. The substance is pre-shaped so that transformation of the substance changes the shape of the substance in a manner which is easy to detect such as a cubic shape or a shape having a uniformly triangular cross section as shown in FIG. 3. In other similar embodiments, the substance may be pre-shaped in the shape of the product (for example a flower as shown in FIG. 7) or may be pre-shaped in the shape of a wedge (as shown in FIG. 8), star, animal, figure, letter or letters, word or words, number or numbers, date, and/or the like. It is to be appreciated that the substance may transform at any predetermined temperature from a solid state to a liquid state.

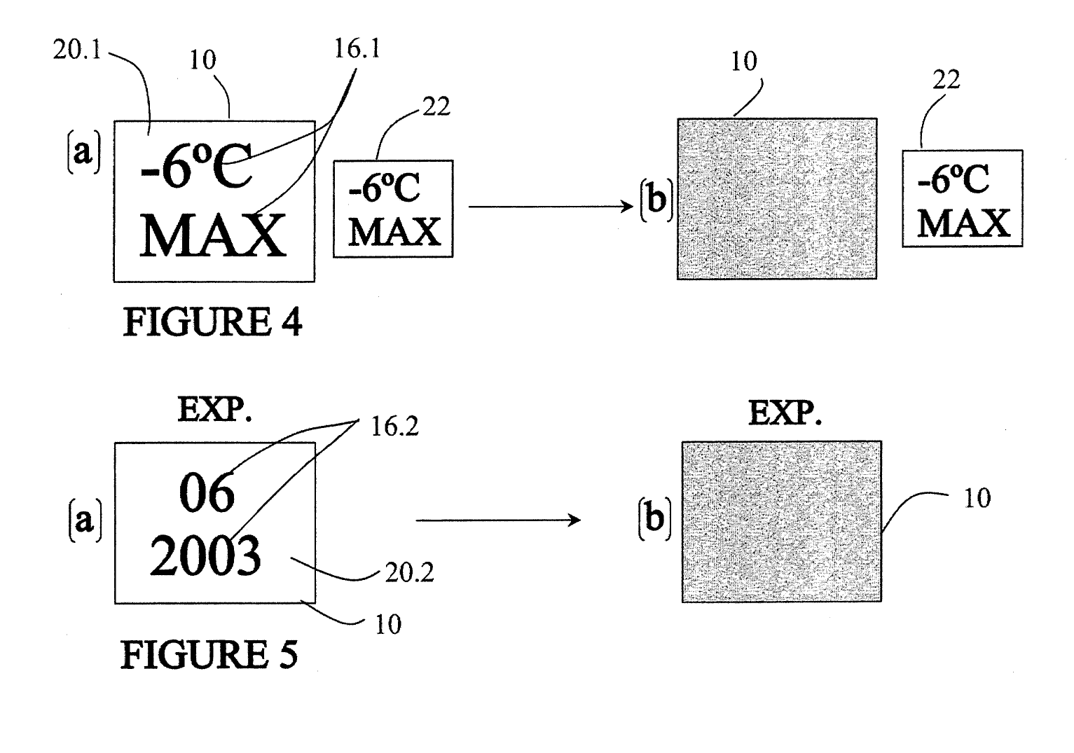

FIG. 4 shows yet another embodiment where the substance is selected and/or chemically formulated to transform at a predetermined temperature of −6° C. The substance includes part 16.1 in the form of coloured symbols, letters, and/or numbers indicating the predetermined transformation temperature of −6° C. Part 16.1 is contained within part 20.1 which is clear or differently coloured to the colour of part 16.1. The accessory 10 also includes a graphical representation 22 of how the substance should look should no transformation have taken place so that a user is able to visually compare the substance with the graphical representation 22 to determine whether or not the substance has transformed.

FIG. 5 shows yet a further embodiment where the substance includes part 16.2 in the form of coloured symbols, letters, and/or numbers indicating the expiry date of the produce in a similar manner to part 16.1 of FIG. 4.

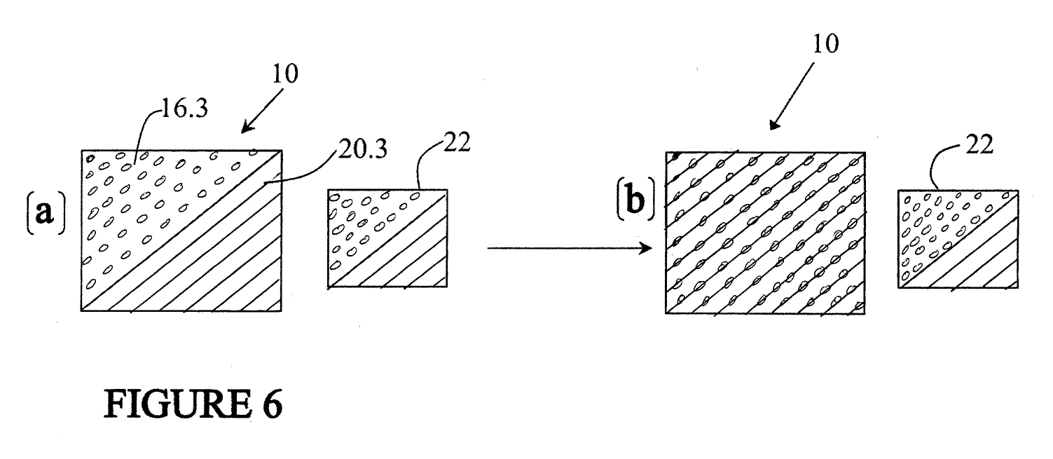

FIG. 6 shows a variation of the embodiment of the accessory 10 shown in FIGS. 1 and 2. In this embodiment the substance includes two differently coloured parts 16.3, 20.3 both of which are shaped to have uniformly triangular cross sections which mix together when the substance transforms from a solid state to a liquid state.

As stated above, the substance is typically selected and/or chemically formulated to transform at a predetermined temperature. Should a predetermined temperature of 0° C. or less be required, substances such as iced water, sodium chloride, calcium chloride and/or alcohol, are typically suitable for selection for transformation from a solid state to a liquid state whereas, should a predetermined temperature of greater than 0° C. be required, substances such as natural waxes, chocolate, cocoa butter, glycerine, gelatine, and/or proteins are typically suitable for selection for transformation from a solid state to a liquid state. In order to lower the transformation temperature of these substances suitable amounts of salt and/or alcohol can be added. Accordingly, an accessory 10 including a suitable substance can be obtained for products such as medicines and pathological samples which should be maintained at temperatures less than about 20° C.; for products such as fruit, flowers, and vegetables which should be maintained at temperatures less than anywhere between about 6° C. and 16° C.; for products such as frozen produce which should be maintained at temperatures less than about −4° C.; and for products such as frozen poultry which should be maintained at temperatures less than about −15° C.

It is to be appreciated that the invention extends to any combination of substances or accessories described herein wherein the substances are transformable on exposure for a predetermined duration, to temperatures within different predetermined temperature ranges so as to provide a visual indicator indicating whether the article has been exposed to temperatures within at least two different predetermined temperature ranges.

It is to be understood that, where applicable, like or similar reference numerals have been used to indicate like or similar features.

It will further be appreciated that the invention is not limited to the precise details as described hereinbefore. For example, the enclosure could be in the form of a sachet or envelope; the substance need not be specifically shaped but could be chemically formulated to change colour on exposure to a temperature that is below or above a certain threshold; and the device could have application in the frozen foods industry or for example, in a laboratory environment where it is necessary that temperature conditions be closely monitored.

1. A temperature exposure indication accessory including a substance which is transformable on exposure for a predetermined duration, to temperatures within a predetermined temperature range, the accessory being attachable to an article at a temperature outside the predetermined temperature range to provide a visual indicator indicating whether the article has been exposed to a temperature within the predetermined temperature range,
provided that, in the case of the substance being water, the substance is transformable by way of a change of colour.

2. A temperature exposure indication accessory as claimed in claim 1, including an enclosure in which said substance is enclosed and which enclosure is attachable to or forms part of a package the temperature exposure of which is required to be indicated.

3. A temperature exposure indication accessory as claimed in claim 2, at least part of the enclosure of which is transparent to permit a user to determine by sight whether the substance in the enclosure has transformed thereby indicating that it has been exposed to a temperature within the predetermined temperature range.

4. A temperature exposure indication accessory as claimed in claim 2, at least part of the enclosure of which is flexible to permit a user to determine by touch whether the substance in the enclosure has transformed thereby indicating that it has been exposed to a temperature within the predetermined temperature range.

5. A temperature exposure indication accessory as claimed in claim 1, wherein the substance is transformable from a solid state to a liquid state.

6. A temperature exposure indication accessory as claimed in claim 5, wherein the substance transforms at a predetermined temperature depending on the indicatory requirements of the accessory.

7. A temperature exposure indication accessory as claimed in claim 1, wherein the shape of the substance is transformable.

8. A temperature exposure indication accessory as claimed in claim 7 wherein the substance is pre-shaped so that transformation of the substance changes the shape of the substance in a manner which is easy to detect.

9. A temperature exposure indication accessory as claimed in claim 1, wherein the colour of the substance is transformable.

10. A temperature exposure indication accessory as claimed in claim 9, wherein the substance includes at least two differently coloured parts which mix together upon transformation so as to change colour.

11. A temperature exposure indication accessory as claimed in claim 9, wherein the substance includes a special dye which changes colour at a predetermined temperature.

12. A temperature exposure indication accessory as claimed in claim 1, which includes at least one other substance which is transformable on exposure for a predetermined duration, to temperatures within a different predetermined temperature range than the first mentioned substance, so as to provide a visual indicator indicating whether the article has been exposed to temperatures within at least two different predetermined temperature ranges.

13. A temperature exposure indication accessory as claimed in claim 1, which includes a graphical representation of how the substance should look should no transformation have taken place so that a user is able to visually compare the substance with the graphical representation to determine whether or not the substance has transformed.

14. An item of packaging for a frozen produce including a temperature exposure indication accessory including a substance which is transformable on exposure for a predetermined duration, to temperatures within a predetermined temperature range, the accessory being attachable to an article at a temperature outside the predetermined temperature range to provide a visual or touch indicator indicating whether the article has been exposed to a temperature within the predetermined temperature range,
provided that, in the case of the substance being water, the substance is transformable by way of a change of colour.

15. An item of packaging for a frozen produce as claimed in claim 14, wherein the accessory forms an integral part of the item of packaging.

16. An item of packaging for a frozen produce as claimed in claim 14, wherein the accessory is permanently attached to the item of packaging.

17. An item of packaging for a frozen produce as claimed in claim 14, wherein the accessory is temporarily attached to the item of packaging.

18. A method of indicating temperature exposure of a frozen article including the steps of:
providing an enclosure having therein a transformable substance at a temperature outside of a predetermined temperature range, provided that, in the case of the substance being water, the substance is transformable by way of a change of colour; and
providing the article with the enclosure at a temperature outside the predetermined temperature range for indicating, at a later time, whether the article has been exposed to a temperature within the pre-determined temperature range.
